(19) United States
(12) Patent Application Publication
(10) Pub. No.: US 2015/0355457 A1
(43) Pub. Date: Dec. 10, 2015

(54) COMPACT ANCHOR FOR EMS DISPLAY ELEMENTS

(71) Applicant: Pixtronix, Inc., San Diego, CA (US)

(72) Inventor: Katsumi Matsumoto, Mobara City (JP)

(21) Appl. No.: 14/296,868

(22) Filed: Jun. 5, 2014

(51) Int. Cl. G02B 26/02; G02B 1/12; G06T 1/60; G09G 5/00; G06T 1/20; G06F 3/01

(52) U.S. Cl. CPC G02B 26/02; G06T 1/20; G06F 3/01; G06T 1/60; G09G 5/00; G02B 1/12

(57) ABSTRACT

This disclosure provides systems, methods and apparatus for shutter-based EMS light modulators controlled by electrode actuators that include a compact anchor. The compact anchor includes four sides. Each of the four sides includes a lower wall, while only three of the sides include a lower shelf, upper wall and eave. That is, a first side includes a lower wall having an upper surface that is substantially the same thickness as the material forming the lower wall.

### TECHNICAL FIELD

This disclosure relates to the field of displays, and in particular, to electromechanical systems (EMS) display elements.

### DESCRIPTION OF THE RELATED TECHNOLOGY

Electromechanical systems (EMS) devices include devices having electrical and mechanical elements, such as actuators, optical components (such as mirrors, shutters, and/or optical film layers) and electronics. EMS devices can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of deposited material layers, or that add layers to form electrical and electromechanical devices.

EMS-based display apparatus have been proposed that include display elements that modulate light by selectively moving a light blocking component into and out of an optical path through an aperture defined through a light blocking layer. Doing so selectively passes light from a backlight or reflects light from the ambient or a front light to form an image.

### SUMMARY

The systems, methods and devices of the disclosure each have several innovative aspects, no single one of which is solely responsible for the desirable attributes disclosed herein.

One innovative aspect of the subject matter described in this disclosure can be implemented in a display apparatus. The apparatus includes a light obstructing component suspended over a substrate, an anchor, and an actuator. The anchor is formed from a structural material, including a first side including a first wall oriented substantially normal to the substrate and a surface furthermost from the substrate having a width defined by the width of an eave extending outward from the wall, and a second side including a second wall oriented substantially normal to the substrate and a surface furthermost form the substrate having a width defined substantially by the thickness of the second wall. The actuator is capable of moving the light obstructing component, where the actuator includes a beam electrode coupled at one end to the anchor and extending along the second side of the anchor.

In some implementations, a height of the first side of the anchor along a dimension substantially normal to the substrate is substantially greater than a height of the second side of the anchor along the same dimension. In some implementations, the beam electrode is suspended over the substrate by a height greater than a height of the second side. In some implementations, the first wall of the first side includes a lower wall and an upper wall joined by a surface oriented substantially parallel to the substrate. In some implementations, the anchor further includes a floor. In some implementations, the apparatus further includes a gap in the floor of the anchor adjacent a base of the second wall.

In some implementations, a closest horizontal distance between a portion of the beam electrode extending alongside the second side of the anchor and an edge of the gap furthest from the beam electrode is about 3 μm. In some implementations, a horizontal distance between a portion of the beam electrode extending alongside the second side of the anchor and an outer surface the second wall is less than about 3 μm.

In some implementations, the apparatus further includes a display, a processor that is configured to communicate with the display, the processor being configured to process image data, and a memory device that is configured to communicate with the processor. In some implementations, the apparatus further includes a driver circuit configured to send at least one signal to the display, and a controller configured to send at least a portion of the image data to the driver circuit. In some implementations, the apparatus further includes an image source module configured to send the image data to the processor, where the image source module includes at least one of a receiver, transceiver, and transmitter. In some implementations, the apparatus further includes an input device configured to receive input data and to communicate the input data to the processor.

Another innovative aspect of the subject matter described in this disclosure can be implemented in a method of forming a display apparatus. The method includes providing a substrate, forming a light obstructing component suspended over the substrate, forming an anchor from a structural material, the anchor including a first side including a first wall oriented substantially normal to the substrate and a surface furthermost from the substrate having a width defined by the width of an eave extending outward from the wall, and a second side including a second wall oriented substantially normal to the substrate and a surface furthermost form the substrate having a width defined substantially by the thickness of the second wall, and forming an actuator capable of moving the light obstructing component, the actuator including a beam electrode coupled at one end to the anchor and extending along the second side of the anchor.

In some implementations, a height of the first side of the anchor along a dimension substantially normal to the substrate is substantially greater than a height of the second side of the anchor along the same dimension. In some implementations, the beam electrode is suspended over the substrate by a height greater than a height of the second side. In some implementations, the first wall of the first side includes a lower wall and an upper wall joined by a surface oriented substantially parallel to the substrate.

In some implementations, the anchor further includes a floor. In some such implementations, the method further includes forming a gap in the flop of the anchor adjacent a base of the second wall. In some implementations, a closest horizontal distance between a portion of the beam electrode extending alongside the second side of the anchor and an edge of the gap furthest from the beam electrode is about 3 μm. In some implementations, a horizontal distance between a portion of the beam electrode extending alongside the second side of the anchor and an outer surface the second wall is less than about 3 μm.

Details of one or more implementations of the subject matter described in this specification are set forth in the accompanying drawings and the description below. Although the examples provided in this summary are primarily described in terms of MEMS-based displays, the concepts provided herein may apply to other types of displays, such as liquid crystal displays (LCD), organic light emitting diode (OLED) displays, electrophoretic displays, and field emission displays, as well as to other non-display MEMS devices, such as MEMS microphones, sensors, and optical switches. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS) based display apparatus.

FIG. 1B shows a block diagram of an example host device.

FIGS. 2A and 2B show views of an example dual actuator shutter assembly.

FIGS. 3A-3D show isometric views of example stages of construction of an example shutter assembly.

FIG. 4 shows an example conventional anchor.

FIGS. 5A-5C show various views of an example compact anchor.

FIG. 6 shows a flow diagram of an example process for forming a compact anchor.

FIGS. 7A-7H show isometric views of example stages of construction of an example compact anchor.

FIG. 8 shows a flow diagram of an example method of forming a display apparatus having a compact anchor.

FIGS. 9A and 9B show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that is capable of displaying an image, whether in motion (such as video) or stationary (such as still images), and whether textual, graphical or pictorial. The concepts and examples provided in this disclosure may be applicable to a variety of displays, such as liquid crystal displays (LCDs), organic light-emitting diode (OLED) displays, field emission displays, and electromechanical systems (EMS) and microelectromechanical (MEMS)-based displays, in addition to displays incorporating features from one or more display technologies.

The described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, wearable devices, clocks, calculators, television monitors, flat panel displays, electronic reading devices (such as e-readers), computer monitors, auto displays (such as odometer and speedometer displays), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, in addition to non-EMS applications), aesthetic structures (such as display of images on a piece of jewelry or clothing) and a variety of EMS devices.

Shutter-based EMS displays can be fabricated to include light modulators controlled by compliant beam electrode actuators. The beam electrodes are supported over a substrate by anchors. At least one anchor can be formed such that all but one side of the anchor include a lower wall, a lower shelf, an upper wall, and an eave extending outward form the top of the upper wall. The last side of the anchor, the side of the anchor along which a beam electrode extends, includes only a lower wall, without a lower shelf, upper wall, or upper shelf. The width of the upper-most surface of that side is equal to about the thickness of the material forming the anchor.

Particular implementations of the subject matter described in this disclosure can be implemented to realize one or more of the following potential advantages. In some implementations, forming an anchor with a side that includes a lower wall without any horizontal surfaces extending away from the lower wall allows a beam electrode supported by the anchor to be fabricated closer to that side of the anchor. Fabricating the portion of the beam electrode closer to the anchor reduces the overall size of the light modulator incorporating the beam electrode and thereby allows for higher resolution displays.

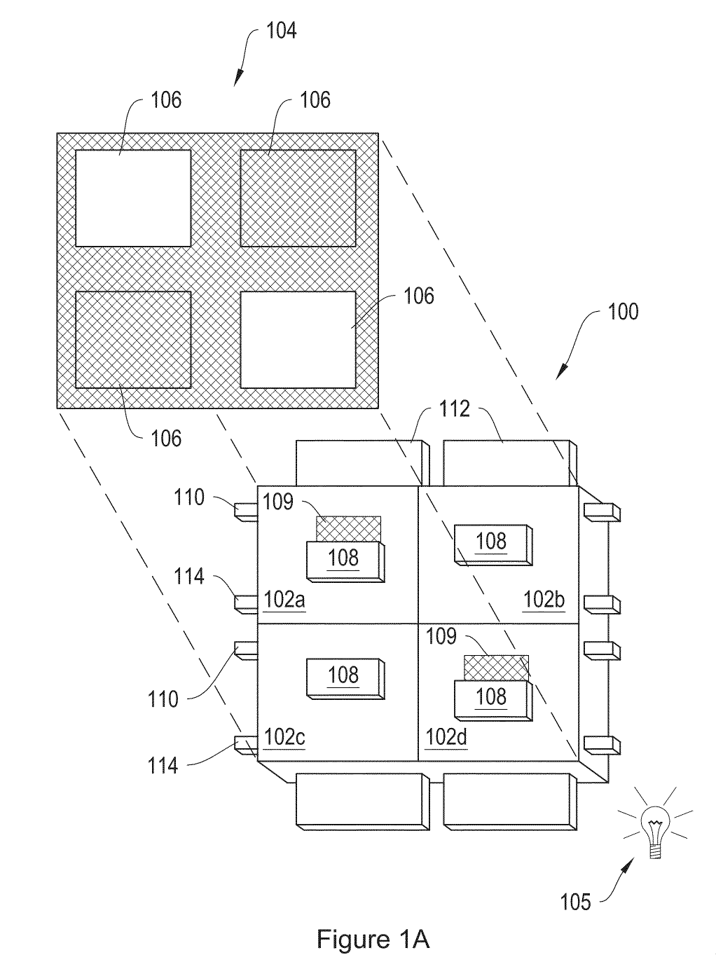

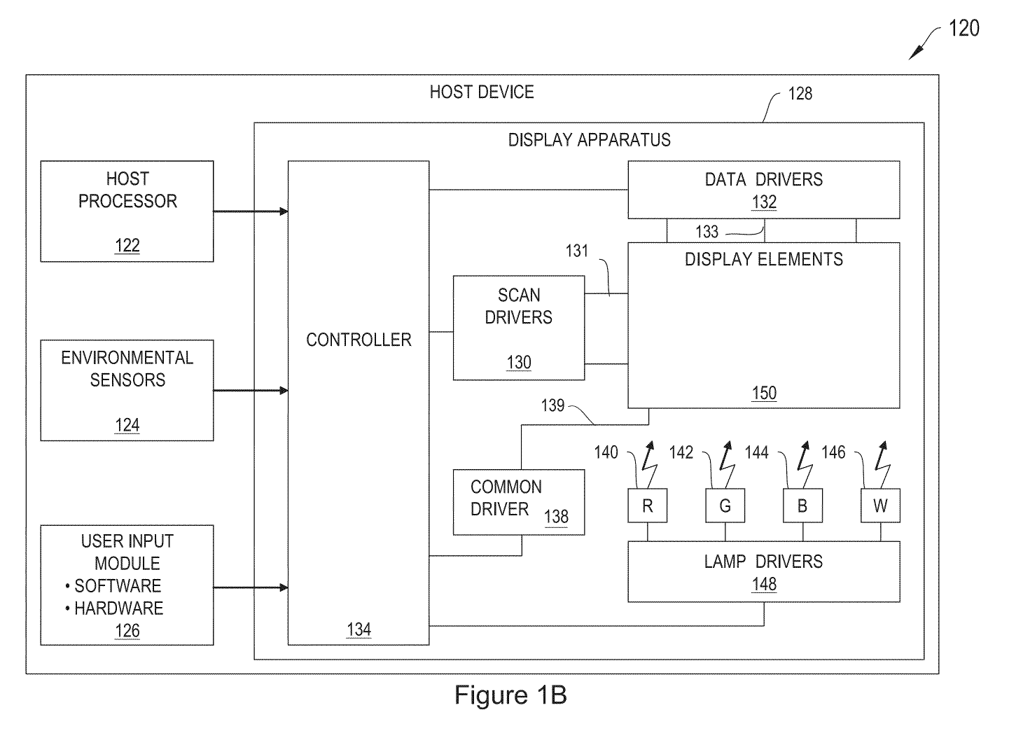

FIG. 1A shows a schematic diagram of an example direct-view MEMS-based display apparatus 100. The display apparatus 100 includes a plurality of light modulators 102a-102d (generally light modulators 102) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide a luminance level in an image 104. With respect to an image, a pixel corresponds to the smallest picture element defined by the resolution of image. With respect to structural components of the display apparatus 100, the term pixel refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the image can be seen by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or backlight so that each pixel can be uniformly illuminated. Transmissive direct-view displays are often built onto transparent substrates to facilitate a sandwich assembly arrangement where one substrate, containing the light modulators, is positioned over the backlight. In some implementations, the transparent substrate can be a glass substrate (sometimes referred to as a glass plate or panel), or a plastic substrate. The glass substrate may be or include, for example, a borosilicate glass, wine glass, fused silica, a soda lime glass, quartz, artificial quartz, Pyrex, or other suitable glass material.

Each light modulator 102 can include a shutter 108 and an aperture 109. To illuminate a pixel 106 in the image 104, the shutter 108 is positioned such that it allows light to pass through the aperture 109. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix coupled to the substrate and to the light modulators for controlling the movement of the shutters. The control matrix includes a series of electrical interconnects (such as interconnects 110, 112 and 114), including at least one write-enable interconnect 110 (also referred to as a scan line interconnect) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the write-enabling voltage, V_{WE}), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate drive voltages, which are typically higher in magnitude than the data voltages, to the light modulators 102. The application of these drive voltages results in the electrostatic driven movement of the shutters 108.

The control matrix also may include, without limitation, circuitry, such as a transistor and a capacitor associated with each shutter assembly. In some implementations, the gate of each transistor can be electrically connected to a scan line interconnect. In some implementations, the source of each transistor can be electrically connected to a corresponding data interconnect. In some implementations, the drain of each transistor may be electrically connected in parallel to an electrode of a corresponding capacitor and to an electrode of a corresponding actuator. In some implementations, the other electrode of the capacitor and the actuator associated with each shutter assembly may be connected to a common or ground potential. In some other implementations, the transistor can be replaced with a semiconducting diode, or a metal-insulator-metal switching element.

FIG. 1B shows a block diagram of an example host device 120 (i.e., cell phone, smart phone, PDA, MP3 player, tablet, e-reader, netbook, notebook, watch, wearable device, laptop, television, or other electronic device). The host device 120 includes a display apparatus 128 (such as the display apparatus 100 shown in FIG. 1A), a host processor 122, environmental sensors 124, a user input module 126, and a power source.

The display apparatus 128 includes a plurality of scan drivers 130 (also referred to as write enabling voltage sources), a plurality of data drivers 132 (also referred to as data voltage sources), a controller 134, common drivers 138, lamps 140-146, lamp drivers 148 and an array of display elements 150, such as the light modulators 102 shown in FIG. 1A. The scan drivers 130 apply write enabling voltages to scan line interconnects 131. The data drivers 132 apply data voltages to the data interconnects 133.

In some implementations of the display apparatus, the data drivers 132 are capable of providing analog data voltages to the array of display elements 150, especially where the luminance level of the image is to be derived in analog fashion. In analog operation, the display elements are designed such that when a range of intermediate voltages is applied through the data interconnects 133, there results a range of intermediate illumination states or luminance levels in the resulting image. In some other implementations, the data drivers 132 are capable of applying only a reduced set, such as 2, 3 or 4, of digital voltage levels to the data interconnects 133. In implementations in which the display elements are shutter-based light modulators, such as the light modulators 102 shown in FIG. 1A, these voltage levels are designed to set, in digital fashion, an open state, a closed state, or other discrete state to each of the shutters 108. In some implementations, the drivers are capable of switching between analog and digital modes.

The scan drivers 130 and the data drivers 132 are connected to a digital controller circuit 134 (also referred to as the controller 134). The controller 134 sends data to the data drivers 132 in a mostly serial fashion, organized in sequences, which in some implementations may be predetermined, grouped by rows and by image frames. The data drivers 132 can include series-to-parallel data converters, level-shifting, and for some applications digital-to-analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 139. In some other implementations, the common drivers 138, following commands from the controller 134, issue voltage pulses or signals to the array of display elements 150, for instance global actuation pulses which are capable of driving and/or initiating simultaneous actuation of all display elements in multiple rows and columns of the array.

Each of the drivers (such as scan drivers 130, data drivers 132 and common drivers 138) for different display functions can be time-synchronized by the controller 134. Timing commands from the controller 134 coordinate the illumination of red, green, blue and white lamps (140, 142, 144 and 146 respectively) via lamp drivers 148, the write-enabling and sequencing of specific rows within the array of display elements 150, the output of voltages from the data drivers 132, and the output of voltages that provide for display element actuation. In some implementations, the lamps are light emitting diodes (LEDs).

The controller 134 determines the sequencing or addressing scheme by which each of the display elements can be re-set to the illumination levels appropriate to a new image 104. New images 104 can be set at periodic intervals. For instance, for video displays, color images or frames of video are refreshed at frequencies ranging from 10 to 300 Hertz (Hz). In some implementations, the setting of an image frame to the array of display elements 150 is synchronized with the illumination of the lamps 140, 142, 144 and 146 such that alternate image frames are illuminated with an alternating series of colors, such as red, green, blue and white. The image frames for each respective color are referred to as color subframes. In this method, referred to as the field sequential color method, if the color subframes are alternated at frequencies in excess of 20 Hz, the human visual system (HVS) will average the alternating frame images into the perception of an image having a broad and continuous range of colors. In some other implementations, the lamps can employ primary colors other than red, green, blue and white. In some implementations, fewer than four, or more than four lamps with primary colors can be employed in the display apparatus 128.

In some implementations, where the display apparatus 128 is designed for the digital switching of shutters, such as the shutters 108 shown in FIG. 1A, between open and closed states, the controller 134 forms an image by the method of time division gray scale. In some other implementations, the display apparatus 128 can provide gray scale through the use of multiple display elements per pixel.

In some implementations, the data for an image state is loaded by the controller 134 to the array of display elements 150 by a sequential addressing of individual rows, also referred to as scan lines. For each row or scan line in the sequence, the scan driver 130 applies a write-enable voltage to the write enable interconnect 131 for that row of the array of display elements 150, and subsequently the data driver 132 supplies data voltages, corresponding to desired shutter states, for each column in the selected row of the array. This addressing process can repeat until data has been loaded for all rows in the array of display elements 150. In some implementations, the sequence of selected rows for data loading is linear, proceeding from top to bottom in the array of display elements 150. In some other implementations, the sequence of selected rows is pseudo-randomized, in order to mitigate potential visual artifacts. And in some other implementations, the sequencing is organized by blocks, where, for a block, the data for only a certain fraction of the image is loaded to the array of display elements 150. For example, the sequence can be implemented to address only every fifth row of the array of the display elements 150 in sequence.

In some implementations, the addressing process for loading image data to the array of display elements 150 is separated in time from the process of actuating the display elements. In such an implementation, the array of display elements 150 may include data memory elements for each display element, and the control matrix may include a global actuation interconnect for carrying trigger signals, from the common driver 138, to initiate simultaneous actuation of the display elements according to data stored in the memory elements.

In some implementations, the array of display elements 150 and the control matrix that controls the display elements may be arranged in configurations other than rectangular rows and columns. For example, the display elements can be arranged in hexagonal arrays or curvilinear rows and columns.

The host processor 122 generally controls the operations of the host device 120. For example, the host processor 122 may be a general or special purpose processor for controlling a portable electronic device. With respect to the display apparatus 128, included within the host device 120, the host processor 122 outputs image data as well as additional data about the host device 120. Such information may include data from environmental sensors 124, such as ambient light or temperature; information about the host device 120, including, for example, an operating mode of the host or the amount of power remaining in the host device's power source; information about the content of the image data; information about the type of image data; and/or instructions for the display apparatus 128 for use in selecting an imaging mode.

In some implementations, the user input module 126 enables the conveyance of personal preferences of a user to the controller 134, either directly, or via the host processor 122. In some implementations, the user input module 126 is controlled by software in which a user inputs personal preferences, for example, color, contrast, power, brightness, content, and other display settings and parameters preferences. In some other implementations, the user input module 126 is controlled by hardware in which a user inputs personal preferences. In some implementations, the user may input these preferences via voice commands, one or more buttons, switches or dials, or with touch-capability. The plurality of data inputs to the controller 134 direct the controller to provide data to the various drivers 130, 132, 138 and 148 which correspond to optimal imaging characteristics.

The environmental sensor module 124 also can be included as part of the host device 120. The environmental sensor module 124 can be capable of receiving data about the ambient environment, such as temperature and or ambient lighting conditions. The sensor module 124 can be programmed, for example, to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

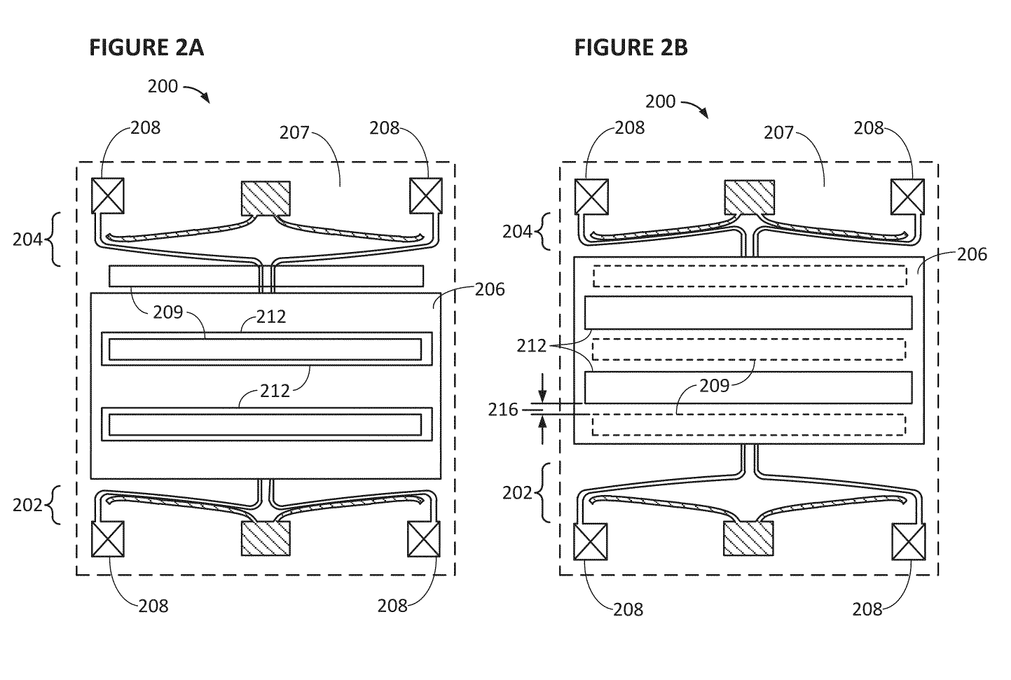

FIGS. 2A and 2B show views of an example dual actuator shutter assembly 200. The dual actuator shutter assembly 200, as depicted in FIG. 2A, is in an open state. FIG. 2B shows the dual actuator shutter assembly 200 in a closed state. The shutter assembly 200 includes actuators 202 and 204 on either side of a shutter 206. Each actuator 202 and 204 is independently controlled. A first actuator, a shutter-open actuator 202, serves to open the shutter 206. A second opposing actuator, the shutter-close actuator 204, serves to close the shutter 206. Each of the actuators 202 and 204 can be implemented as compliant beam electrode actuators. The actuators 202 and 204 open and close the shutter 206 by driving the shutter 206 substantially in a plane parallel to an aperture layer 207 over which the shutter is suspended. The shutter 206 is suspended a short distance over the aperture layer 207 by anchors 208 attached to the actuators 202 and 204. Having the actuators 202 and 204 attach to opposing ends of the shutter 206 along its axis of movement reduces out of plane motion of the shutter 206 and confines the motion substantially to a plane parallel to the substrate (not depicted).

In the depicted implementation, the shutter 206 includes two shutter apertures 212 through which light can pass. The aperture layer 207 includes a set of three apertures 209. In FIG. 2A, the shutter assembly 200 is in the open state and, as such, the shutter-open actuator 202 has been actuated, the shutter-close actuator 204 is in its relaxed position, and the centerlines of the shutter apertures 212 coincide with the centerlines of two of the aperture layer apertures 209. In FIG. 2B, the shutter assembly 200 has been moved to the closed state and, as such, the shutter-open actuator 202 is in its relaxed position, the shutter-close actuator 204 has been actuated, and the light blocking portions of the shutter 206 are now in position to block transmission of light through the apertures 209 (depicted as dotted lines).

Each aperture has at least one edge around its periphery. For example, the rectangular apertures 209 have four edges. In some implementations, in which circular, elliptical, oval, or other curved apertures are formed in the aperture layer 207, each aperture may have only a single edge. In some other implementations, the apertures need not be separated or disjointed in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through the apertures 212 and 209 in the open state, the width or size of the shutter apertures 212 can be designed to be larger than a corresponding width or size of apertures 209 in the aperture layer 207. In order to effectively block light from escaping in the closed state, the light blocking portions of the shutter 206 can be designed to overlap the edges of the apertures 209. FIG. 2B shows an overlap 216, which in some implementations can be predefined, between the edge of light blocking portions in the shutter 206 and one edge of the aperture 209 formed in the aperture layer 207.

The electrostatic actuators 202 and 204 are designed so that their voltage-displacement behavior provides a bi-stable characteristic to the shutter assembly 200. For each of the shutter-open and shutter-close actuators, there exists a range of voltages below the actuation voltage, which if applied while that actuator is in the closed state (with the shutter being either open or closed), will hold the actuator closed and the shutter in position, even after a drive voltage is applied to the opposing actuator. The minimum voltage needed to maintain a shutter's position against such an opposing force is referred to as a maintenance voltage Vₘ.

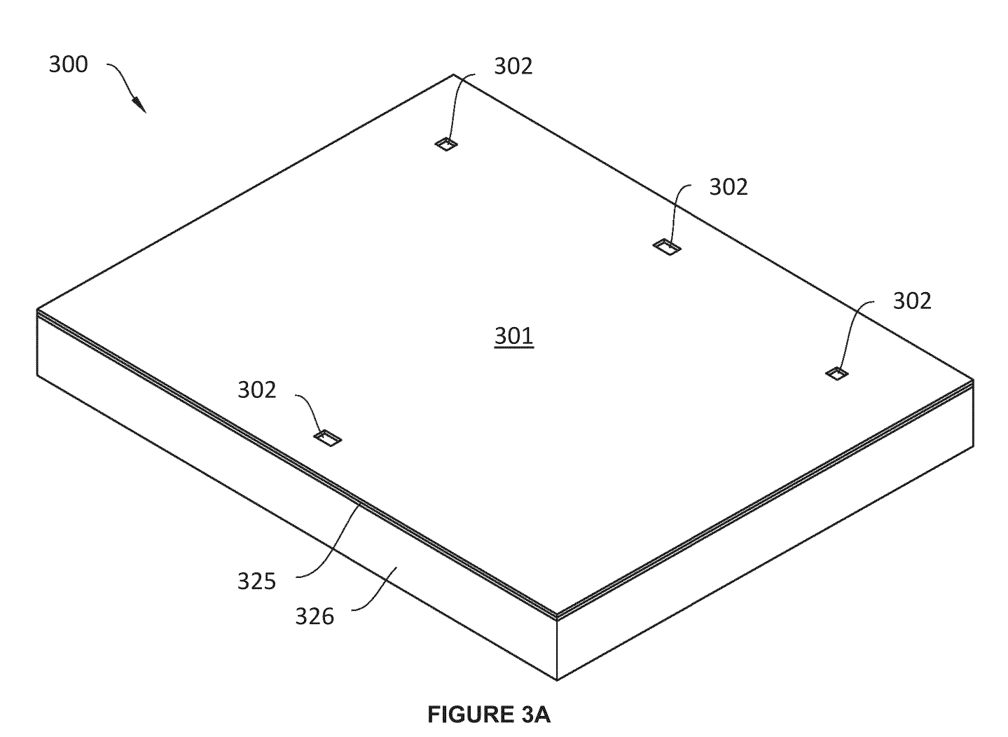

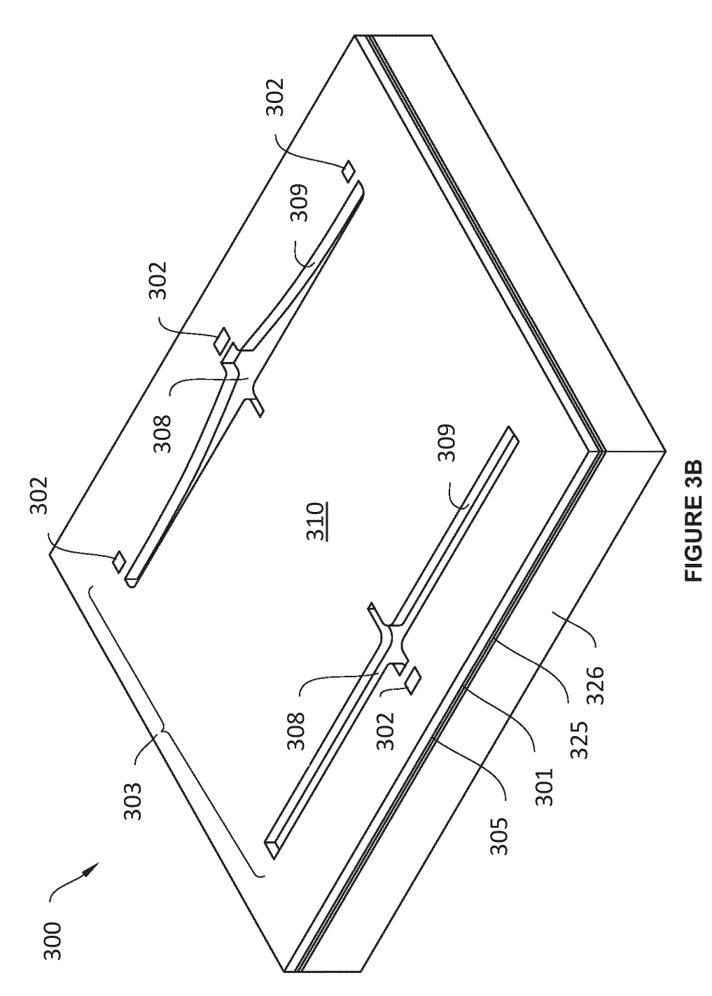

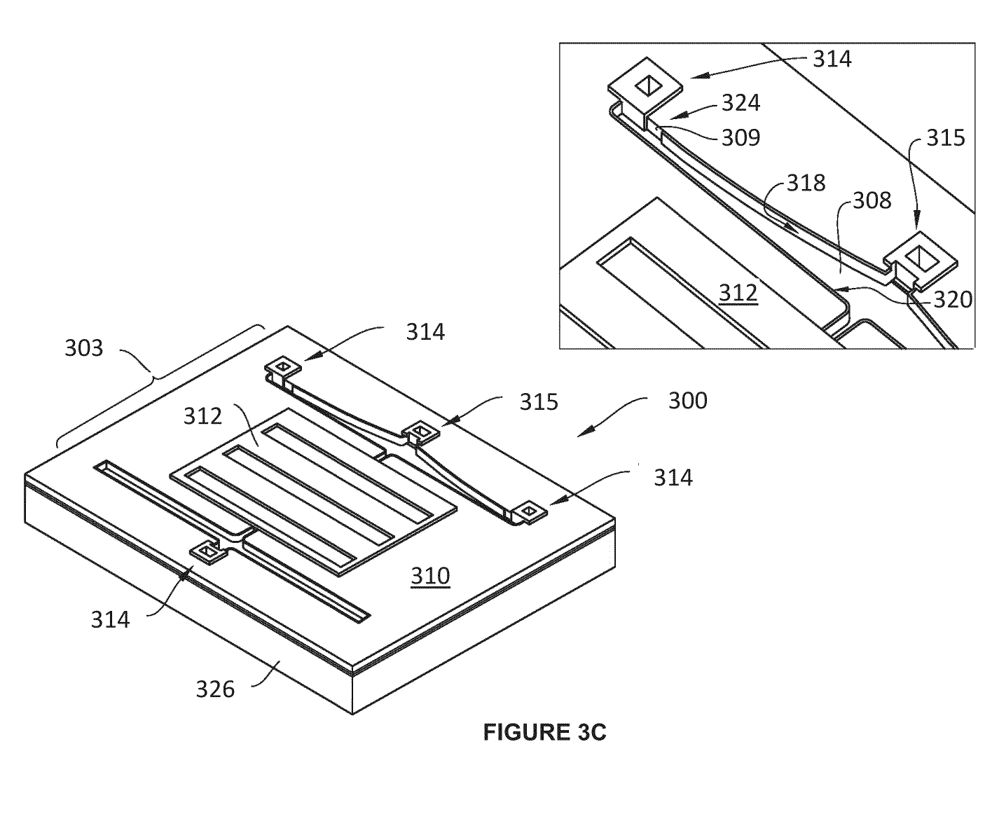

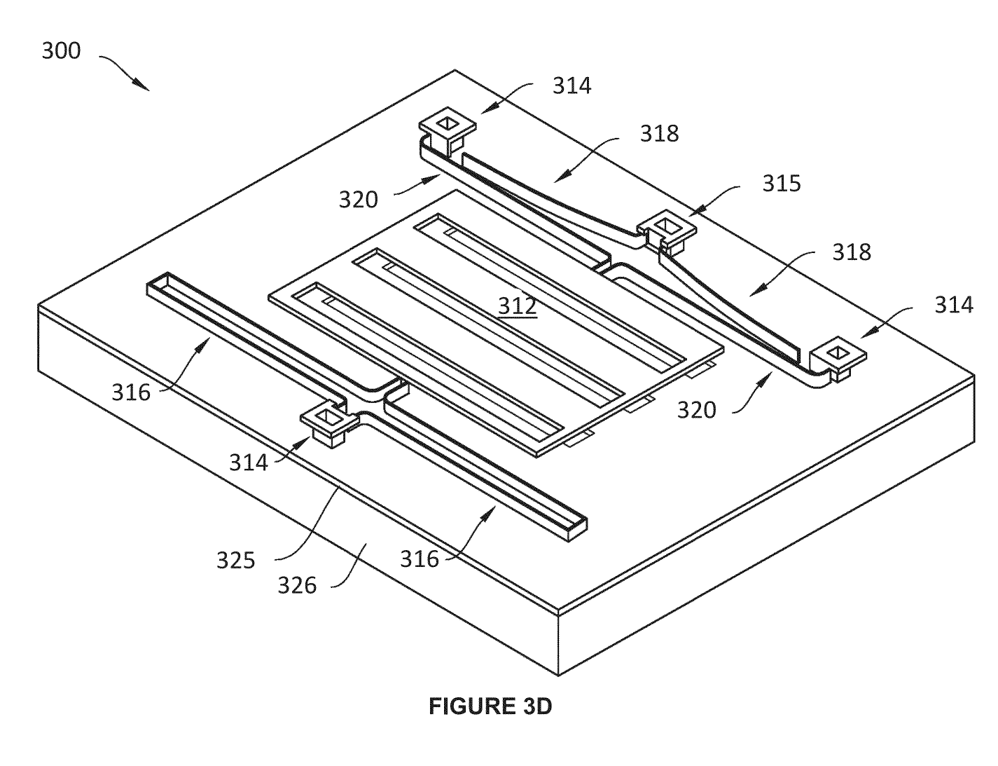

FIGS. 3A-3D show isometric views of stages of construction of an example shutter assembly 300 with narrow sidewall beams. This process yields compliant actuator beams 318 and 320 and a compliant spring beam 316 (collectively referred to as “sidewall beams 316, 318 and 320”), which have a width well below the conventional lithography limits on large glass panels. In the process depicted in FIGS. 3A-3D, the compliant beams of shutter assembly 300 are formed as sidewall features on a mold made from a sacrificial material. The process is referred to as a sidewall beams process.

The process of forming the shutter assembly 300 with the sidewall beams 316, 318 and 320 begins, as depicted in FIG. 3A, with the deposition and patterning of a first sacrificial material 301. The pattern defined in the first sacrificial material 301 creates openings or vias 302 within which anchors for the shutter assembly 300 eventually will be formed.

The process of forming the sidewall beams 316, 318 and 320 continues with the deposition and patterning of a second sacrificial material 305. FIG. 3B shows the shape of a mold 303 that is created after patterning of the second sacrificial material 305. The mold 303 also includes the first sacrificial material 301 with its previously defined vias 302. The mold 303 in FIG. 3B includes two distinct horizontal levels. The bottom horizontal level 308 of the mold 303 is established by the top surface of the first sacrificial layer 301 and is accessible in those areas where the second sacrificial material 305 has been etched away. The top horizontal level 310 of the mold 303 is established by the top surface of the second sacrificial material 305. The mold 303 depicted in FIG. 3B also includes substantially vertical sidewalls 309.

Materials for use as the first and second sacrificial materials 301 and 305 include polyimide. Other candidate sacrificial layer materials include, without limitation, polymer materials such as polyamide, fluoropolymer, benzocyclobutene, polyphenylquinoxylene, parylene, or polynorbornene. These materials are chosen for their ability to planarize rough surfaces, maintain mechanical integrity at processing temperatures in excess of 250° C., and their ease of etch and/or thermal decomposition during removal. In other implementations, the sacrificial layer 301 and/or 305 is formed from a photoresist, such as polyvinyl acetate, polyvinyl ethylene, and phenolic or novolac resins. An alternate sacrificial layer material used in some implementations is SiO₂, which can be removed preferentially as long as other electronic or structural layers are resistant to the hydrofluoric acid solutions used for its removal. One such suitable resistant material is Si₃N₄. Another alternate sacrificial layer material is Si, which can be removed preferentially as long as electronic or structural layers are resistant to the fluorine plasmas or xenon difluoride (XeF₂) used for its removal, such as most metals and Si₃N₄. Yet another alternate sacrificial layer material is Al, which can be removed preferentially as long as other electronic or structural layers are resistant to strong base solutions, such as concentrated sodium hydroxide (NaOH) solutions. Suitable materials include, for example, Cr, Ni, Mo, Ta and Si. Still another alternate sacrificial layer material is Cu, which can be removed preferentially as long as other electronic or structural layers are resistant to nitric or sulfuric acid solutions. Such materials include, for example, Cr, Ni, and Si.

The process of forming the sidewall beams 316, 318 and 320 continues with the deposition and patterning of shutter material onto all of the exposed surfaces of the sacrificial mold 303, as depicted in FIG. 3C. The elements of the composite shutter 312 include a first mechanical layer, a conductor layer, a second mechanical layer and/or a dielectric. At least one of the mechanical layers can be deposited to thicknesses in excess of 0.15 microns, as one or both of the mechanical layers serves as the principal load bearing and mechanical actuation member for the shutter assembly, though in some implementations, the mechanical layers may be thinner. Candidate materials for the mechanical layers include, without limitation, metals such as aluminum (Al), copper (Cu), nickel (Ni), chromium (Cr), molybdenum (Mo), titanium (Ti), tantalum (Ta), niobium (Nb), neodymium (Nd), or alloys thereof; dielectric materials such as aluminum oxide (Al₂O₃), silicon oxide (SiO₂), tantalum pentoxide (Ta₂O₅), or silicon nitride (Si₃N₄); or semiconducting materials such as diamond-like carbon, silicon (Si), germanium (Ge), gallium arsenide (GaAs), cadmium telluride (CdTe) or alloys thereof. At least one of the layers, such as the conductor layer, should be electrically conducting so as to carry charge on to and off of the actuation elements. Candidate materials include, without limitation, Al, Cu, Ni, Cr, Mo, Ti, Ta, Nb, Nd, or alloys thereof or semiconducting materials such as diamond-like carbon, Si, Ge, GaAs, CdTe or alloys thereof. In some implementations employing semiconductor layers, the semiconductors are doped with impurities such as phosphorus (P), arsenic (As), boron (B), or Al.

In some implementations, the order of the layers in the composite shutter assembly 300 can be inverted, such that the outside of the shutter assembly 300 is formed from a conductor layer while the inside of the shutter assembly 300 is formed from a mechanical layer. In some implementations, the shutter assembly includes only one conductor layer and one mechanical layer.

The shutter material is deposited to a thickness of less than about 2 microns. In some implementations, the shutter material is deposited to have a thickness of less than about 1.5 microns. In some other implementations, the shutter material is deposited to have a thickness of less than about 1.0 microns, and as thin as about 0.10 microns. After deposition, the shutter material (which may be a composite of several materials as described above) is patterned. First, a photoresist is deposited on the shutter material. The photoresist is then patterned. The pattern developed into the photoresist is designed such that the shutter material, after a subsequent etch stage, remains in the region of the shutter 312 as well as at the anchors 314.

The manufacturing process continues with applying an anisotropic etch, resulting in the structure depicted in FIG. 3C. The anisotropic etch of the shutter material is carried out in a plasma atmosphere with a voltage bias applied to the substrate 326 or to an electrode in proximity to the substrate 326. The biased substrate 326 (with electric field perpendicular to the surface of the substrate 326) leads to acceleration of ions toward the substrate 326 at an angle nearly perpendicular to the substrate 326. Such accelerated ions, coupled with the etching chemicals, lead to etch rates that are much faster in a direction that is normal to the plane of the substrate 326 as compared to directions parallel to the substrate 326. Undercut-etching of shutter material in the regions protected by a photoresist is thereby substantially eliminated. Along the vertical sidewalls 309 of the mold 303, which are substantially parallel to the track of the accelerated ions, the shutter material also is substantially protected from the anisotropic etch. Such protected sidewall shutter material forms the sidewall beams 316, 318, and 320 for supporting the shutter 312. Along other (non-photoresist-protected) horizontal surfaces of the mold 303, such as the top horizontal surface 310 or the bottom horizontal surface 308, the shutter material has been substantially completely removed by the etch.

The process of forming the sidewall beams 316, 318 and 320 is completed with the removal of the remainder of the second sacrificial material 305 and the first sacrificial material 301. The result is shown in FIG. 3D. The sacrificial layer is removed, which frees-up all moving parts from the substrate, except at the anchor points 314. In some implementations, polyimide sacrificial materials are removed in an oxygen plasma. Other polymer materials used for the sacrificial layer also can be removed in an oxygen plasma, or in some cases by thermal pyrolysis. Some sacrificial layer materials (such as SiO₂) can be removed by wet chemical etching or by vapor phase etching.

The material deposited on the vertical sidewalls 309 of the mold 303 remain as the sidewall beams 316, 318 and 320. The sidewall beam 316 serves as a spring mechanically connecting the anchors 314 to the shutter 312, and also provides a passive restoring force and to counter the forces applied by the actuator formed from the compliant beams 318 and 320. The anchors 314 connect to an aperture layer 325. The sidewall beams 316, 318 and 320 are tall and narrow. The width of the sidewall beams 316, 318 and 320, as formed from the surface of the mold 303, is similar to the thickness of the shutter material as deposited. In some implementations, the width of sidewall beam 316 will be the same as the thickness of shutter 312. In some other implementations, the beam width will be about ½ the thickness of the shutter 312. The height of the sidewall beams 316, 318 and 320 is determined by the thickness of the second sacrificial material 305, or in other words, by the depth of the mold 303, as created during the patterning operation described in relation to FIG. 3B. As long as the thickness of the deposited shutter material is chosen to be less than about 2 microns, the process depicted in FIGS. 3A-3D is well suited for the production of narrow beams. In fact, for many applications a thickness range of 0.1 to 2.0 microns is quite suitable. Conventional photolithography would limit the patterned features shown in FIGS. 3A, 3B and 3C to much larger dimensions, for instance allowing minimum resolved features no smaller than 2 microns or 5 microns.

FIG. 3D depicts an isomeric view of the shutter assembly 300, formed after the release operation in the above-described process, yielding compliant beams with cross sections of high aspect ratios. As long as the thickness of the second sacrificial material 305 is, for example, greater than about 4 times larger than the thickness of the shutter material, the resulting ratio of beam height to beam width will be produced to a similar ratio, i.e., greater than about 4:1.

An optional stage, not illustrated above but included as part of the process leading to FIG. 3C, involves isotropic etching of the sidewall beam material to separate or decouple the compliant load beams 320 from the compliant drive beams 318. For instance, the shutter material at point 324 has been removed from the sidewall through use of an isotropic etch. An isotropic etch is one whose etch rate is substantially the same in all directions, so that sidewall material in regions such as point 324 is no longer protected. The isotropic etch can be accomplished in the typical plasma etch equipment as long as a bias voltage is not applied to the substrate 326. An isotropic etch also can be achieved using wet chemical or vapor phase etching techniques. Prior to this optional fourth masking and etch stage, the sidewall beam material exists essentially continuously around the perimeter of the recessed features in the mold 303. The fourth mask and etch stage is used to separate and divide the sidewall material, forming the distinct beams 318 and 320. The separation of the beams 318 and 320 at point 324 is achieved through a fourth process of photoresist dispense, and exposure through a mask. The photoresist pattern in this case is designed to protect the sidewall beam material against isotropic etching at all points except at the separation point 324.

As a final stage in the sidewall process, an encapsulating dielectric is deposited around the outside surfaces of the sidewall beams 316, 318 and 320.

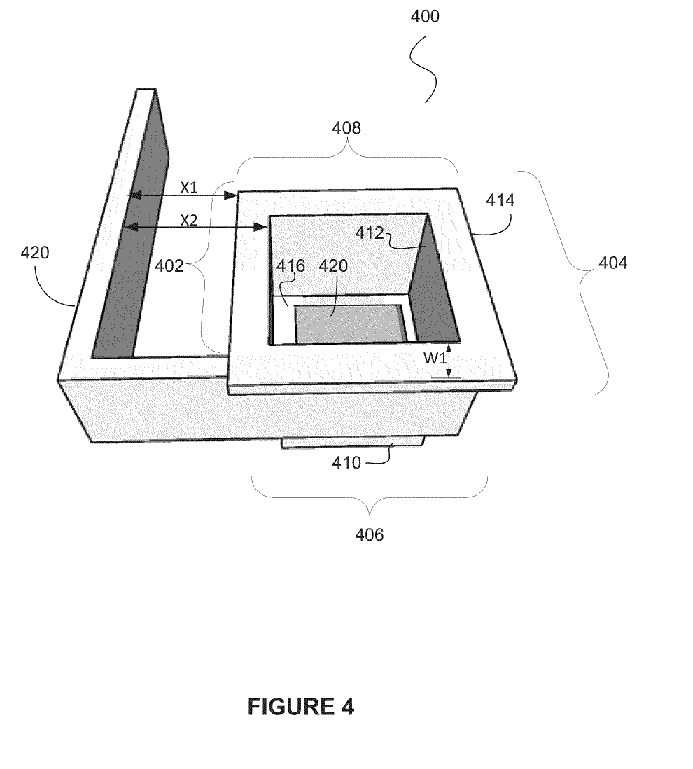

FIG. 4 shows an example conventional anchor 400. The anchor 400 can be constructed in a manner similar to the anchors 314 shown in FIG. 3D. The anchor 400 includes four sides: a front side 402 proximate to a beam electrode 420; a rear side 404 opposite the beam electrode 420; a left side 406; and a right side 408. As shown, a beam electrode 420 extends out from the left side 406. In some implementations, the beam electrode 420 extends out from the right side 408.

The four sides (402, 404, 406, and 408) of the anchor 400 each includes a lower wall 410 adjacent to a substrate layer (such as substrate 326 shown in FIG. 3D) and an upper wall 412. The lower wall 410 and upper wall 412 are substantially normal to the substrate. The four sides (402, 404, 406, and 408) also include an eave 414 and a horizontal surface 416 that are both substantially parallel to the substrate.

The beam electrode 420 can be constructed in a manner similar to the sidewall beam 320 shown in FIG. 3D. The beam electrode 420 is separated from a portion of the eave 414 on the front side 402 of the anchor 400 by a separation distance X1. The separation distance X1 is based on manufacturing design tolerances. In some implementations, the separation distance X1 is greater than about 3 μm due to the manufacturing design tolerances.

The beam electrode 420 is separated from the lower wall 410 by a separation distance of X2. The separation distance X2 is greater than the separation distance X1. In some implementations, the difference between the separation distances X2 and X1 is based on a width W1 of the eave 414, which can range from about 1 μm to about 20 μm.

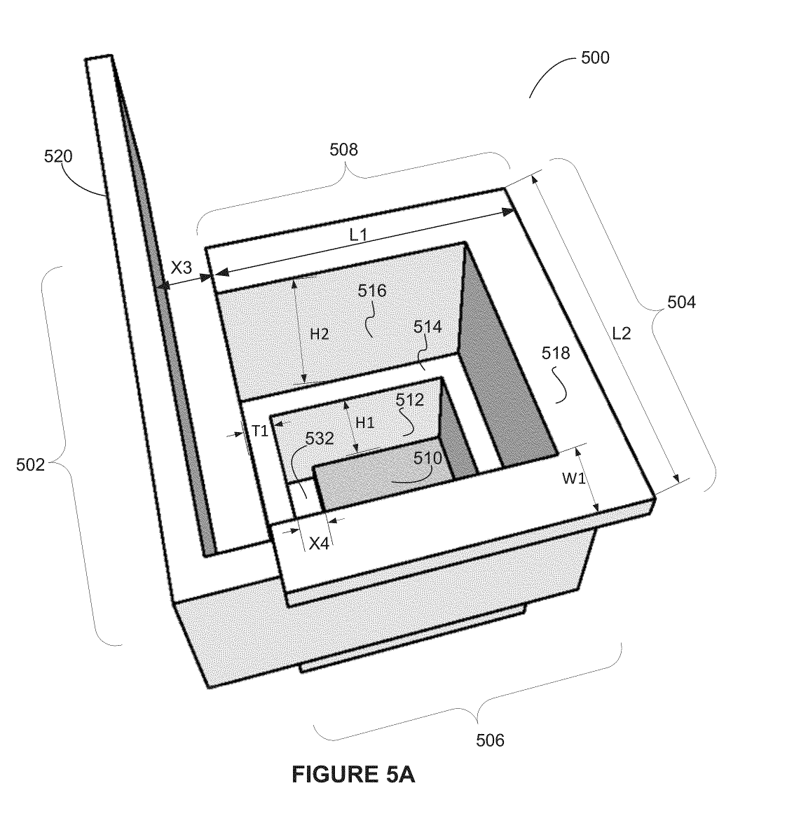

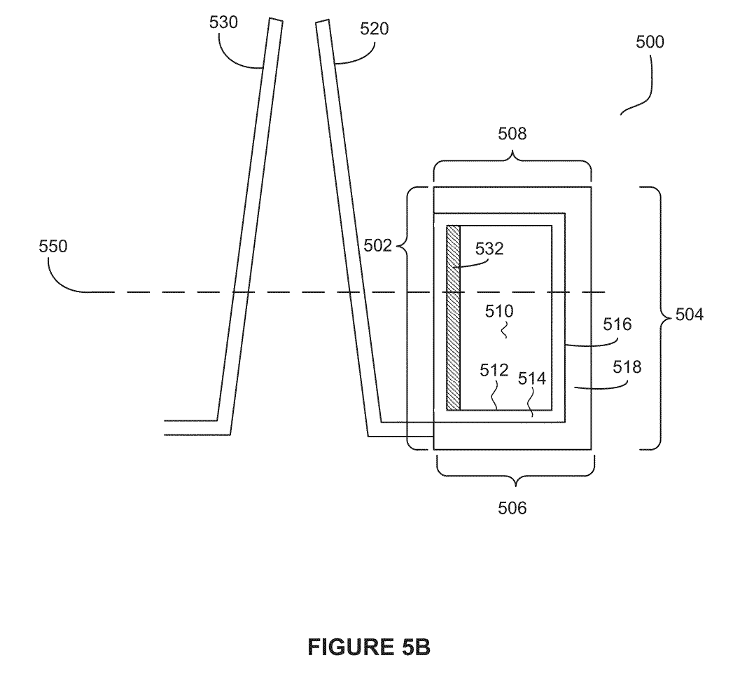

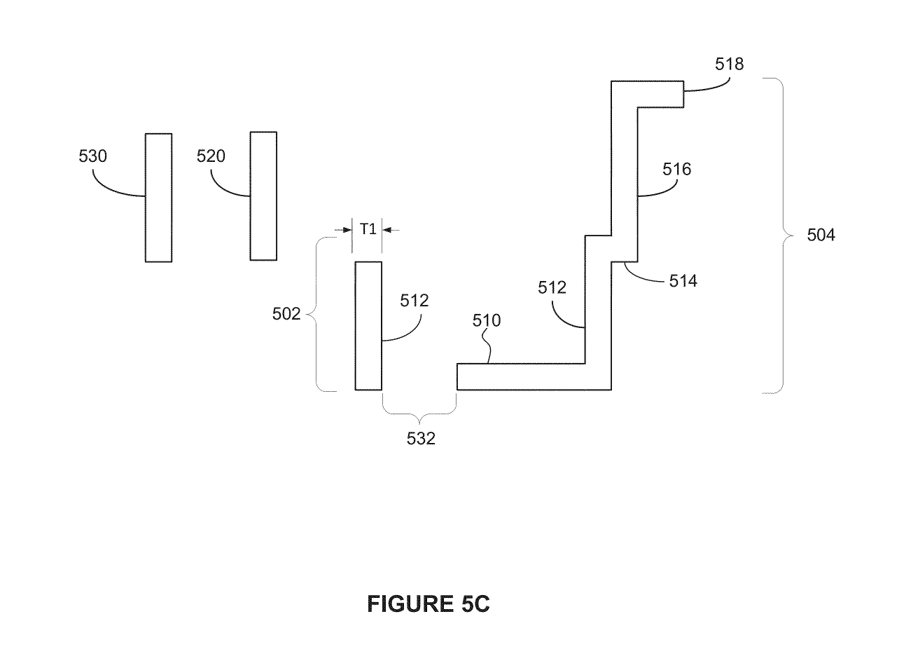

FIGS. 5A-5C show various views of an example compact anchor 500. FIG. 5A shows a perspective view of the anchor 500. FIG. 5B shows a top view of the anchor 500 and FIG. 5C shows a cross sectional view of the anchor 500. Referring to FIGS. 5A-5C, the compact anchor 500 includes four sides: a front side 502 proximate to a beam electrode 520; a rear side 504 opposite the beam electrode 520; a left side 506; and a right side 508. A beam electrode 520 extends out from the left side 506.

The rear side 504, left side 506 and right side 508 of the anchor 500 each include a lower wall 512 and an upper wall 516 that are substantially normal to an anchor floor 510. The rear side 504, right side 508 and left side 506 of the anchor 500 each also include a lower shelf 514 and an eave 518 that are substantially parallel to the anchor floor 510. The lower shelf 514 supports the upper wall 516.

In some implementations, a height H1 of the lower wall 512 above the anchor floor 510 can range from about 2 μm to about 7 μm. In some implementations, a height H2 of the upper wall above the lower shelf 514 can range from about 2 μm to about 7 μm. In some implementations, an overall height (i.e., H1+H2) can range from about 4 μm to about 14 μm.

A length L1 of the left side 506 and the right side 508 can range from about 6 μm to about 15 μm. A length L2 of the front side 502 and rear side 504 can also range from about 6 μm to about 15 μm.

The lower wall 512 and upper wall 516 can have a thickness ranging from about 0.5 μm to about 2 μm. A thickness T1 of the lower shelf 514 can be substantially similar to a thickness of the lower wall 512. A width W1 of the eave 518 can be greater than the thickness T1 of the lower shelf 514 or a thickness of a material of the upper wall 516. In some implementations, the width W1 of the eave ranges from about 2 μm to about 5 μm.

The front side 502 of the anchor 500 includes the lower wall 512. The front side 502 of the anchor 500, however, does not include the lower shelf 514, upper wall 516 or the eave 518. That is, the upper-most surface of the front side 502 has a dimension T1 normal to the lower wall 512 of the front side 502 that is substantially equal to the thickness of a material forming the front side 502. The front side 502 of the anchor 500 also lacks any horizontal surfaces above the anchor floor 510 that are substantially greater than the thickness of the lower wall 512.

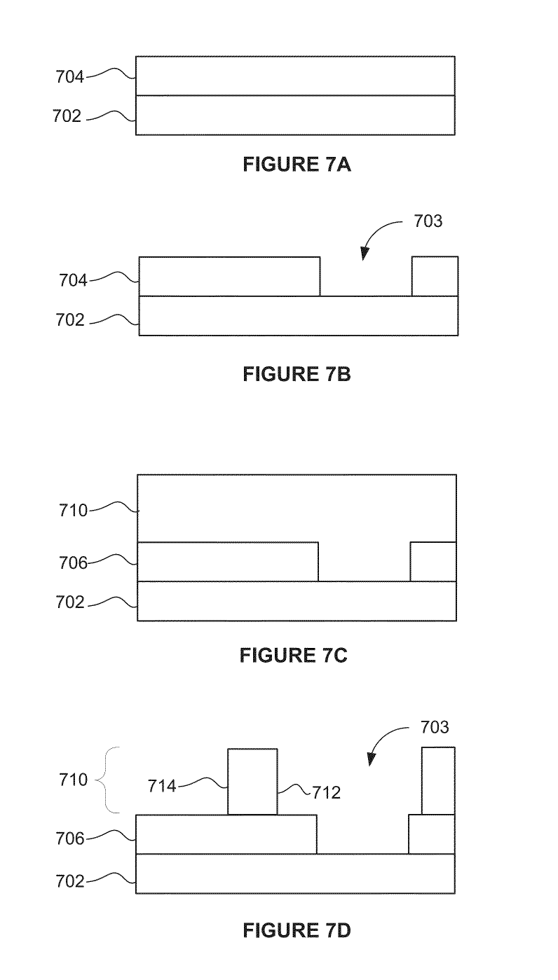

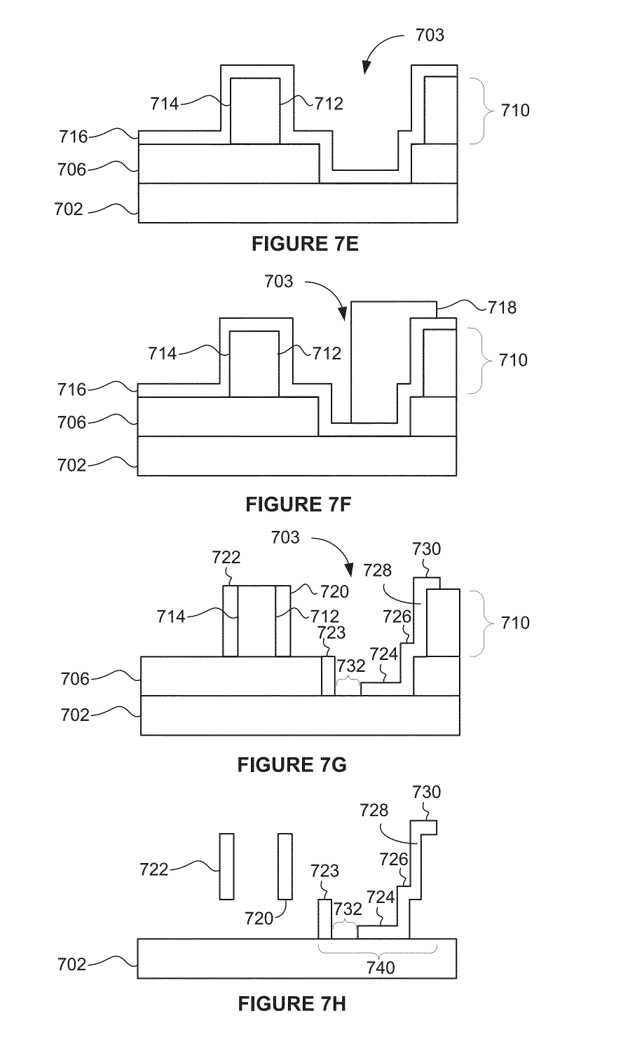

The anchor 500 can include a gap 532 in the anchor floor 510 adjacent the front side 502. As will be shown in FIGS. 7A-7H, the gap 532 can result from fabrication of the compact anchor 500. Specifically, the gap is formed to ensure that material that would otherwise form the lower shelf 514 is fully removed from the front side 502 of the anchor 500. The width X4 of the gap can be based on manufacturing design tolerances (e.g., the distance between the rear edge of the gap 532 and the edge of the beam electrode 520 is greater than the minimum feature size allowable given the manufacturing design tolerances), and can be less than, for example, about 3 μm.

A beam electrode 520 extends out from the left side 506 of the anchor 500. A length of the beam electrode 520 can range from about 20 μm to about 100 μm. The thickness of the beam electrode 520 can range from about 0.5 μm to about 2 μm. In some implementations, the height of the beam electrode 520 can range from about 2 μm to about 7 μm. In some implementations, the height of the beam electrode 520 is substantially similar to the height H2 of the upper wall 516. The beam electrode 520 can be configured to receive an actuation voltage (such as about 5V to about 20V) or a bias voltage such as ground or other low magnitude voltage (for example, up to about 3V). In some implementations, an end of the beam electrode 520 can be coupled to a shutter or other light obstructing component.

The front side 502 of the anchor 500 is separated from the beam electrode 520 by a separation distance X3. The separation distance X3 is based on manufacturing design tolerances. In some implementations, the separation distance X3 is less than or equal to about 3 μm.

Due to the front side 502 lacking an eave or horizontal surface above the anchor floor 510 with a width greater than the thickness T1 of the lower wall 512, the separation distance X3 between the beam electrode 520 and the lower wall 512 may be less than the separation distance X2 shown in FIG. 4, and can even be less than the minimum feature size allowed by the minimum design tolerance. That is, the separation distance X3 of the compact anchor 500 can be less than the separation distance X2 of the conventional anchor 400 because the minimum feature size applies to the distance between the beam electrode 520 and the rear edge of the gap 532 in the floor 510 of the anchor, instead of the distance between the beam electrode 520 and the front edge of an eave.

The compact anchor 500 may be formed from or include one or more materials that facilitate operation of the compact anchor 500. Candidate materials can include, without limitation, semiconducting materials such as diamond-like carbon, amorphous silicon (a-Si), silicon (Si), germanium (Ge), gallium arsenide (GaAs), cadmium telluride (CdTe) and alloys thereof, or metals such as aluminum (Al), copper (Cu), nickel (Ni), chromium (Cr), molybdenum (Mo), titanium (Ti), tantalum (Ta), niobium (Nb), neodymium (Nd), or alloys thereof; dielectric materials such as aluminum oxide (Al₂O₃), silicon oxide (SiO₂), tantalum pentoxide (Ta₂O₅), or silicon nitride (Si₃N₄); or. In some implementations, the anchor 500 may be formed with multiple layers. At least one of the layers, such as the conductor or semi-conductor layer, should be electrically conducting so as to carry charge on to and off of the actuation elements. Candidate materials include, without limitation, Al, Cu, Ni, Cr, Mo, Ti, Ta, Nb, Nd, or alloys thereof or semiconducting materials such as diamond-like carbon, Si, Ge, GaAs, CdTe or alloys thereof. In some implementations employing semiconductor layers, the semiconductors are doped with impurities such as phosphorus (P), arsenic (As), boron (B), or Al.

FIG. 5B shows a top-down view of the example compact anchor 500. FIG. 5C shows a cross sectional-view of the compact anchor 500. FIGS. 5B and 5C show an additional component, a second beam electrode 530, not shown in FIG. 5A. The second beam electrode 530 can serve as the opposing electrode of an electrostatic actuator.

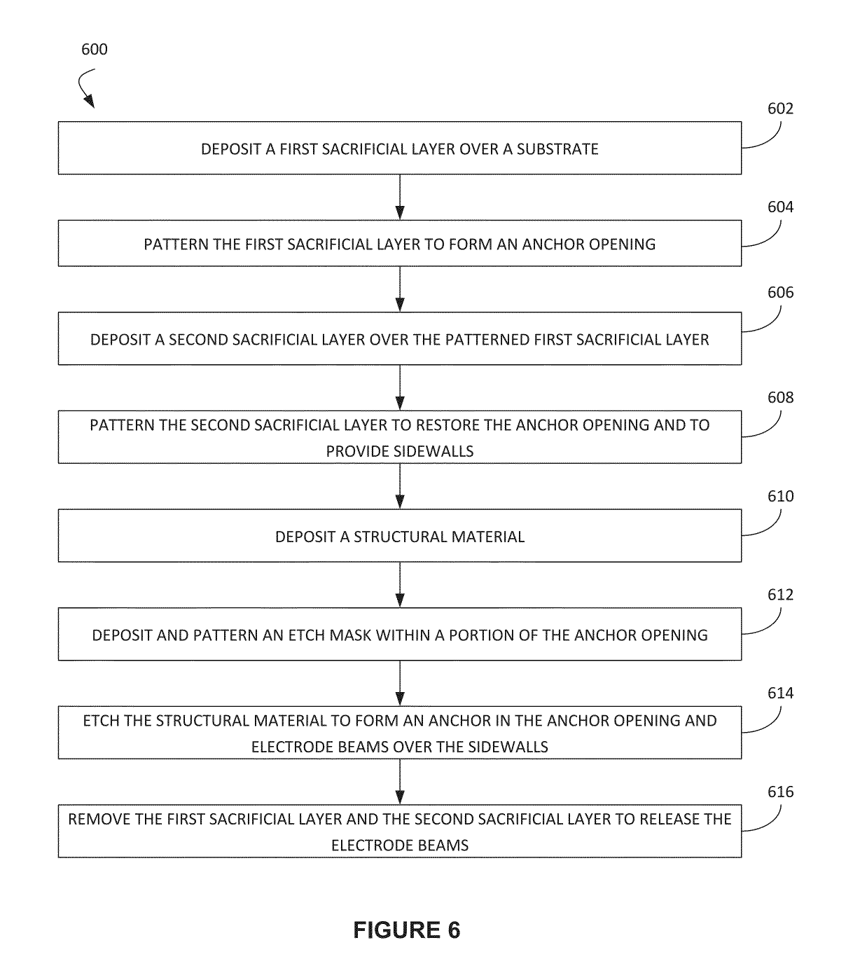

FIG. 6 shows a flow diagram of an example process 600 for forming a compact anchor. FIGS. 7A-7H show cross-sectional views of example stages of construction of the process 600 shown in FIG. 6. This process 600 can yield the compact anchor 500 shown in FIGS. 5A-5C that includes a front side having a lower wall but lacking a lower shelf, upper wall and eave. The manufacturing process 600 employed to construct the anchor 500 may be similar to the processes described in FIGS. 3A-3D, but employing different etch masks and process stages to obtain the compact anchor 500 instead of the anchors formed through the process shown in FIGS. 3A-3D.

The process 600 includes depositing a first sacrificial layer (stage 602), patterning the first sacrificial layer to form an anchor opening (stage 604), depositing a second sacrificial layer over the patterned first sacrificial layer (stage 606), patterning the second sacrificial layer to restore the anchor opening and provide sidewalls (stage 608), depositing a structural material (stage 610), depositing and patterning an etch mask (stage 612), etching the structural material to form an anchor in the anchor opening and beam electrodes over the sidewalls (stage 614), and removing the first sacrificial layer and the second sacrificial layer (stage 616).

The process 600 includes depositing a first sacrificial layer over a substrate (stage 602). An example result of the process stage 602 is shown in FIG. 7A, in which a first sacrificial layer 704 is deposited over a substrate 702. In some implementations, the substrate 702 can be a transparent substrate made of glass or plastic. The substrate 702, for example, can be similar to the substrate 326 shown in FIGS. 3A-3D. The first sacrificial layer 704 can be formed using methods and materials similar to those discussed above in relation to the first and second sacrificial materials 301 and 305 in FIGS. 3A-3D.

The process 600 further includes patterning the first sacrificial layer to form an anchor opening (stage 604). An example result of the process stage 604 is shown in FIG. 7B, in which the first sacrificial layer 704 is patterned to form an anchor opening 703. As discussed below, the anchor opening 703 can be used to form an anchor.

The process 600 also includes depositing a second sacrificial layer over the patterned first sacrificial layer (stage 606). An example result of this process stage 606 is shown in FIG. 7C, in which a second sacrificial layer 710 is deposited over the patterned first sacrificial layer 704. In some implementations, the second sacrificial layer 710 can be deposited using methods, and materials, discussed above in relation to the first and second sacrificial materials 301 and 305 in FIGS. 3A-3D.

The process 600 further includes patterning the second sacrificial layer to restore the anchor opening and provide sidewalls (stage 608). An example result of this process stage 608 is shown in FIG. 7D, in which the second sacrificial layer 710 is patterned to restore the anchor opening 703 and to form a first sidewall 712 and a second sidewall 714. In some implementations, the patterning of the second sacrificial layer 710 can be carried out using methods similar to those discussed above in relation to patterning the first and second sacrificial materials 301 and 305 shown in FIGS. 3A-3D. As discussed below, the first and the second sidewalls 712 and 714 can be used for forming a first and second beam electrodes of an actuator, while the restored anchor opening 703 can be used to form an anchor.

The process 600 further includes depositing a structural material (stage 610). An example result of this process stage 610 is shown in FIG. 7E, in which a structural material 716 is deposited over the patterned first and second sacrificial layers 706 and 710. In some implementations, the structural material 716 can include materials, and can be deposited using methods, discussed above in relation to the shutter materials used to form the shutter assembly 310 in FIGS. 3C and 3D. For example, the structural material can include multiple layers, including a semiconductor layer and one or more metal layers.

The process 600 also includes depositing and patterning an etch mask (stage 612). An example result of this process stage 612 is shown in FIG. 7F, in which an etch mask 718 is formed over a portion of the structural material 716 deposited in the anchor opening 703. In some implementations, the etch mask 718 can be formed by first depositing a photoresist material, exposing the photoresist material through a photomask, and developing the exposed photoresist material to form the etch mask 718.

The process 600 further includes etching the structural material to form an anchor in the anchor opening 703 and beam electrodes 720 and 722 over the sidewalls (stage 614). An example result of this process stage 614 is shown in FIG. 7G, in which an anisotropic etch, followed by the removal of the etch mask 718, results in the structure shown in FIG. 7G. The anisotropic etch can be carried out in a manner similar to that discussed above in relation to FIG. 3C. The anisotropic etching results in the a higher rate of etching over surfaces that are substantially parallel to the substrate 702 in comparison to the rate of etching over surfaces that are substantially normal to the substrate 702. Furthermore, surfaces covered by etch masks are preserved. As a result, the structural material 716 is retained over the first and second sidewall 712 and 714 to form the first beam electrode 720 and the second beam electrode 722. Furthermore, the structural material 716 is retained over a vertical surface of the first sacrificial layer 706 within the anchor opening 703 to form a lower anchor wall 723. In addition, the surfaces of the anchor opening 703 covered by the etch mask 718 are also retained to form the anchor floor 724, a lower anchor shelf 726, an upper anchor wall 728, and an eave 730.

The anisotropic etching also results in a gap 732 formed between the lower anchor wall 722 and the anchor floor 724. The gap 732 can be similar to the gap 532 shown in FIGS. 5A-5C. Specifically, the gap 732 is formed to ensure that the structural material 716 that would otherwise form the lower anchor shelf 726 is fully removed from a side of the anchor proximate to the first beam electrode 720. That is, due to the design tolerances of the patterning and etching process, intentionally etching the structural material 716 away from the lower wall within the anchor helps ensure, even with some process error, the etch will fully remove structural material 716 between the lower wall and the first beam electrode 720.

The process 600 additionally includes removing the first sacrificial layer and the second sacrificial layer (stage 616). An example result of this process stage 616 is shown in FIG. 7H, in which the first sacrificial layer 706 and the second sacrificial layer 710 are removed resulting in the release of the first and the second beam electrodes 720 and 722. The lower anchor wall 723, the anchor floor 724, the lower anchor shelf 726, the upper anchor wall 728, and the eave 730, in combination, form a compact anchor 740.

While not shown in FIGS. 7A-7F, the process 600 also includes the formation of a shutter and one or more actuators in conjunction with the formation of the first and second beam electrodes 720 and 722 and the compact anchor 740.

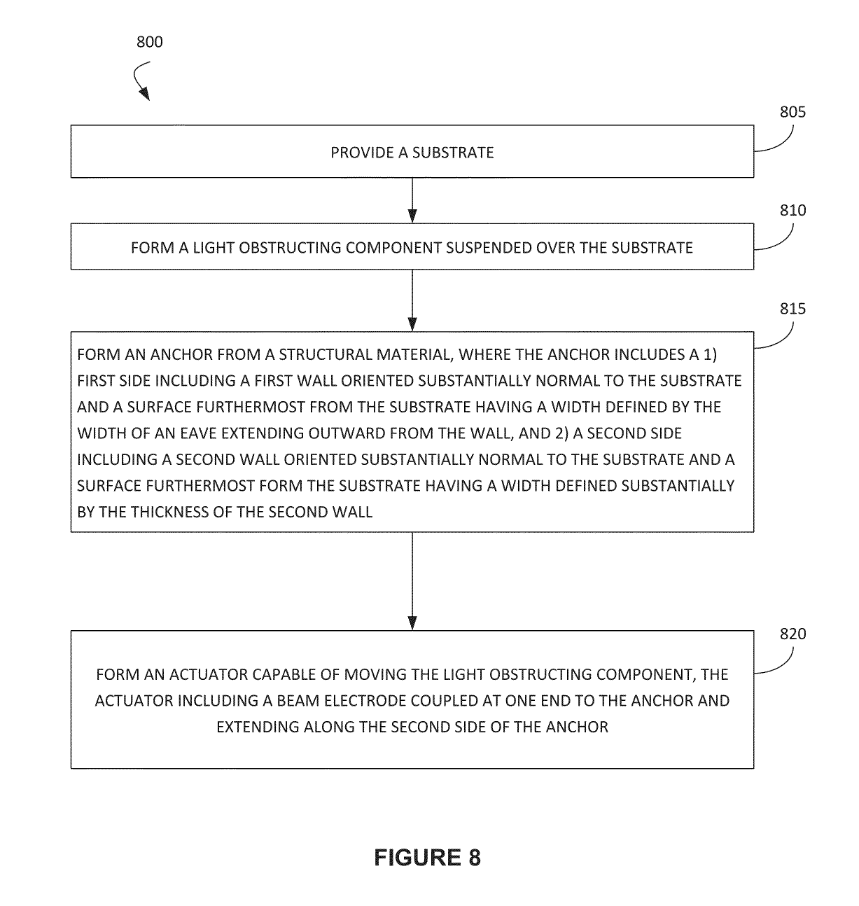

FIG. 8 shows a flow diagram of an example process 800 of forming a display apparatus with a compact anchor. The process 800 includes providing a substrate (stage 805). The process 800 includes forming a light obstructing component suspended over the substrate (stage 810). The process 800 includes forming an anchor from a structural material such that the anchor includes a first side and a second side (stage 815). The first side includes a first wall oriented substantially normal to the substrate and a surface furthermost from the substrate having a width defined by the width of an eave extending outward from the wall. The second side includes a second wall oriented substantially normal to the substrate and a surface furthermost form the substrate having a width defined substantially by the thickness of the second wall. The process 800 includes forming an actuator capable of moving the light obstructing component, where the actuator includes a beam electrode coupled at one end to the anchor and which extends along the second side of the anchor (stage 820). The process 800 can include one or more stages and employ one or more materials of the manufacturing processes discussed with respect to FIGS. 3A-3D and FIGS. 6-7H. For example, the substrate provided at stage 805 can correspond to the substrate 702 (shown in FIGS. 7A-7H), and the anchor and actuator formed at stages 815 and 820 can be formed using the process stages 602-616 of FIG. 6.

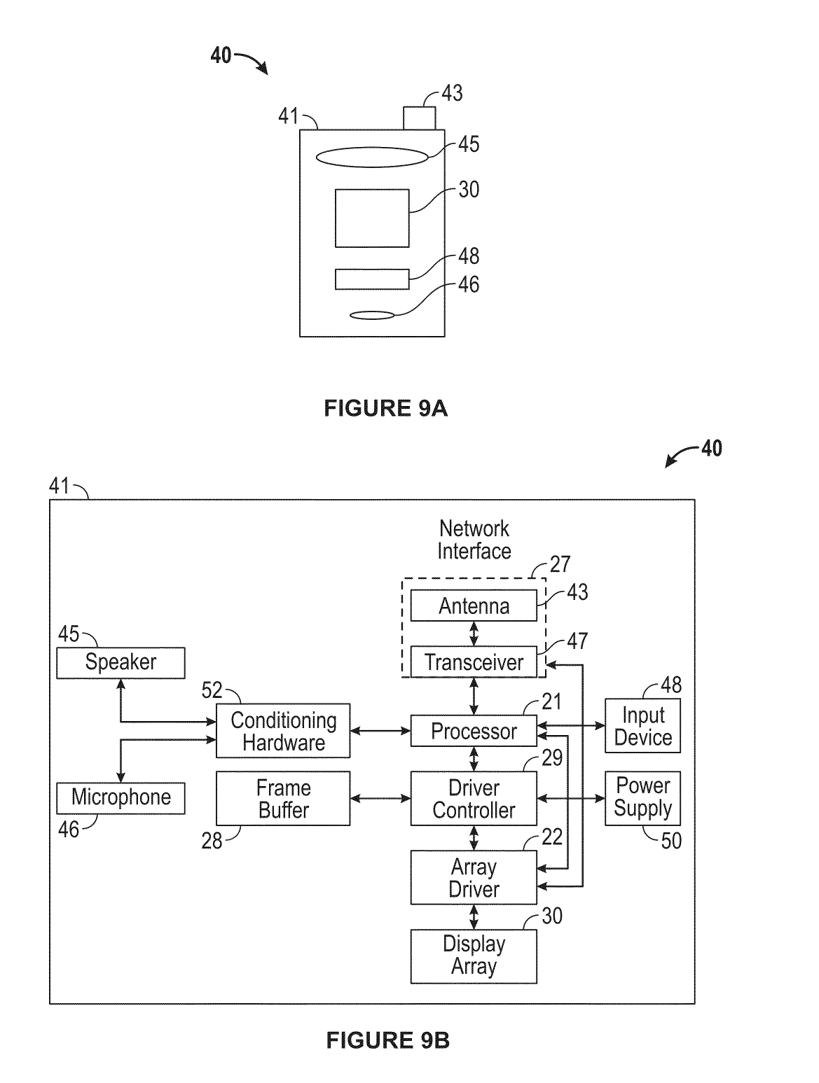

FIGS. 9A and 9B show system block diagrams of an example display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be capable of including a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 9B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 9A, can be capable of functioning as a memory device and be capable of communicating with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to any of the IEEE 16.11 standards, or any of the IEEE 802.11 standards. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G, or further implementations thereof, technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29 is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40. Additionally, in some implementations, voice commands can be used for controlling display parameters and settings.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

1. An apparatus, comprising:
a light obstructing component suspended over a substrate;
an anchor, formed from a structural material, including:
a first side including a first wall oriented substantially normal to the substrate and a surface furthermost from the substrate having a width defined by the width of an eave extending outward from the wall; and
a second side including a second wall oriented substantially normal to the substrate and a surface furthermost form the substrate having a width defined substantially by the thickness of the second wall; and
an actuator capable of moving the light obstructing component, the actuator including a beam electrode coupled at one end to the anchor and extending along the second side of the anchor.

2. The apparatus of claim 1, wherein a height of the first side of the anchor along a dimension substantially normal to the substrate is substantially greater than a height of the second side of the anchor along the same dimension.

3. The apparatus of claim 1, wherein the beam electrode is suspended over the substrate by a height greater than a height of the second side.

4. The apparatus of claim 1, wherein the first wall of the first side includes a lower wall and an upper wall joined by a surface oriented substantially parallel to the substrate

5. The apparatus of claim 1, wherein the anchor further includes a floor.

6. The apparatus of claim 5, further comprising a gap in the flop of the anchor adjacent a base of the second wall.

7. The apparatus of claim 6, wherein a closest horizontal distance between a portion of the beam electrode extending alongside the second side of the anchor and an edge of the gap furthest from the beam electrode is about 3 μm.

8. The apparatus of claim 1, wherein a horizontal distance between a portion of the beam electrode extending alongside the second side of the anchor and an outer surface the second wall is less than about 3 μm.

9. The apparatus of claim 1, further comprising:
a display;
a processor that is configured to communicate with the display, the processor being configured to process image data; and
a memory device that is configured to communicate with the processor.

10. The apparatus of claim 9, further comprising:
a driver circuit configured to send at least one signal to the display; and
a controller configured to send at least a portion of the image data to the driver circuit.

11. The apparatus of claim 9, further comprising:
an image source module configured to send the image data to the processor, wherein the image source module comprises at least one of a receiver, transceiver, and transmitter.

12. The apparatus of claim 9, further comprising:
an input device configured to receive input data and to communicate the input data to the processor.

13. A method of forming a display apparatus, comprising:
providing a substrate;
forming a light obstructing component suspended over the substrate;
forming an anchor from a structural material, the anchor including:
a first side including a first wall oriented substantially normal to the substrate and a surface furthermost from the substrate having a width defined by the width of an eave extending outward from the wall; and
a second side including a second wall oriented substantially normal to the substrate and a surface furthermost form the substrate having a width defined substantially by the thickness of the second wall; and
forming an actuator capable of moving the light obstructing component, the actuator including a beam electrode coupled at one end to the anchor and extending along the second side of the anchor.

14. The method of claim 13, wherein a height of the first side of the anchor along a dimension substantially normal to the substrate is substantially greater than a height of the second side of the anchor along the same dimension.

15. The method of claim 13, wherein the beam electrode is suspended over the substrate by a height greater than a height of the second side.

16. The method of claim 13, wherein the first wall of the first side includes a lower wall and an upper wall joined by a surface oriented substantially parallel to the substrate

17. The method of claim 13, wherein the anchor further comprises a floor.

18. The method of claim 17, further comprising forming a gap in the flop of the anchor adjacent a base of the second wall.

19. The method of claim 18, wherein a closest horizontal distance between a portion of the beam electrode extending alongside the second side of the anchor and an edge of the gap furthest from the beam electrode is about 3 μm.

20. The method of claim 13, wherein a horizontal distance between a portion of the beam electrode extending alongside the second side of the anchor and an outer surface the second wall is less than about 3 μm.
